(19) United States
(12) Patent Application Publication
(10) Pub. No.: US 2025/0272737 A1
(43) Pub. Date: Aug. 28, 2025

(54) E-COMMERCE INTELLIGENT DISTRIBUTION SYSTEM

(71) Applicant: XUHUI CAI, SINGAPORE (SG)

(72) Inventor: XUHUI CAI, SINGAPORE (SG)

(21) Appl. No.: 18/585,233

(22) Filed: Feb. 23, 2024

(51) Int. Cl. G06Q 30/0601; G06Q 30/0201

(52) U.S. Cl. CPC G06Q 30/0631; G06Q 30/0201

(57) ABSTRACT

An E-commerce intelligent distribution system includes a data collection module wherein the data collection module is configured to collect and record data related to users, products and transactions; a data processing module wherein the data processing module is configured to preprocess the collected data; a data extraction module; a prediction module; a distribution module; an iteration module; and a background terminal. The E-commerce intelligent distribution system can visually display the extracted data in the form of charts, reports through the backend terminal, supports real-time data extraction, making it convenient for operators to observe the extracted data in real time, and provides real-time feedback on the user's interest trend in the current environment based on the extracted data; the prediction module of the E-commerce intelligent distribution system can recommend personalized content or product that best suits the user's interests based on the user's characteristics and behavior patterns.

The present disclosure relates to a technical field of intelligent distribution, and more particular to an E-commerce intelligent distribution system.

### BACKGROUND

E-commerce is a business operation model, which refers to a wide range of commercial trade activities across the world. E-commerce occurs in an open network environment of the Internet. Based on the client/server application model, buyers and sellers conduct various transactions online without face-to-face contact. The main contents of E-commerce include consumers' online shopping, online transactions between merchants and online electronic payments, as well as various business activities, trading activities, financial activities, and related comprehensive service activities.

The E-commerce intelligent distribution system is an automated distribution platform based on artificial intelligence technology. The E-commerce intelligent distribution system can automatically recommend and distribute relevant content, products or services based on user needs and interests by analyzing user behavior, historical data, and other information to improve user experience and marketing effectiveness.

At present, processing of such problems typically relies on manual monitoring and adaptation of user requirements. This needs to match the content with the user and search the user terminal through the matching result. However, such a method requires a large amount of computing work and cannot effectively save network resources.

### SUMMARY

The present disclosure provides an E-commerce intelligent distribution system, aiming to solve above existing technical problems.

An E-commerce intelligent distribution system includes a data collection module wherein the data collection module is configured to collect and record data related to users, products, and transactions.

A data processing module, which is communicated with the data collection module, is configured to preprocess the recorded data and remove invalid data and abnormal values.

A data extraction module, which is communicated with the data processing module, is configured to extract relevant features from data after preprocessed and perform sieving to the relevant features according to an importance of the features.

A data prediction module, which is communicated with the data extraction module, is configured to predict user's preferences level in specific content or products by analyzing user's behavioral data including browsing history, search history, and upvote records, and the prediction module simultaneously predict the user's future behavior trend based on the user's behavior data.

A data distribution module, which is communicated with the prediction module, is configured to automatically recommend pertinent products and services according to the user's requirements and preferences level.

An iteration module is configured to collect various real-time user data.

Optionally, the data collection module is configured to obtains data from various data sources, including user behavior data, product information and content data; and thereafter reasonably store collected data for subsequent analysis.

Optionally, the data processing module is configured to integrate and convert data from different sources and formats, process a real-time data; and thereafter store data after consolidated.

Optionally, the prediction module is configured to analyze the data extracted by the data extraction module, and record analysis results, and recommend and distribute arrangements in advance based on the analysis results.

Optionally, the distribution module is configured to recommend personalized content or products to users based on preferences and behavioral characteristics thereof.

Optionally, the iteration module is configured to monitor and analyze the data collection module, mark defective data, and transmit marked data to the background terminal.

Optionally, the background terminal is configured to repair the data marked by the iteration module and to visually display the real-time data.

The present disclosure provides an E-commerce intelligent distribution system. The E-commerce intelligent distribution system can visually display the extracted data in the form of charts, reports through the backend terminal; supports real-time data extraction, making it convenient for operators to observe the extracted data in real time, and provides real-time feedback on the user's interest trend in the current environment based on the extracted data; the prediction module of the E-commerce intelligent distribution system can recommend personalized content or product that best suits the user's interests based on the user's characteristics and behavior patterns.

### BRIEF DESCRIPTION OF DRAWINGS

FIG. 1 is a block diagram of an E-commerce intelligent distribution system according to one embodiment of the present disclosure.

Reference numerals in the drawing: 1: a data collection module; 2: a data processing module; 3: a data extraction module; 4: a prediction module; 5: a distribution module; 6: an iteration module; 7: a background terminal.

### DETAILED DESCRIPTION

Technical solutions in the embodiments of the present disclosure will be described clearly and completely in the following by referring to the accompanying drawings of the present disclosure. Apparently, the described embodiments are only a part of but not all the embodiments of the present disclosure. All other embodiments, which are obtained by any ordinary skilled person in the art based on the embodiments in the present disclosure without making creative work, shall fall within the protection scope of the present disclosure.

In the specification of the present disclosure, it is noted that terms “center”, “up”, “down”, “left”, “right”, “vertical”, “horizontal”, “inside”, “outside” and the like indicate orientations or positional relationships based on those shown in the accompanying drawings. The terms are used to describe the present disclosure and to simplify the description, instead of indicating or suggesting that the referred device or element must be arranged in the orientation or configured and operated in the orientation. Therefore, the terms shall not be interpreted as limiting the present disclosure. Terms “first”, “second” and “third” are used for descriptive purposes only and shall be interpreted as indicating or implying relative significance. In addition, unless otherwise expressly specified and limited, terms “mount”, “connect” and “link” shall be interpreted broadly. For example, the terms can indicate fixed connection, detachable connection, or connection into an integral and one-piece structure; mechanical connection, electrical connection; direct connection; or indirect connection through an intermediate medium; or connection of two internal elements. Any ordinary skilled person in the art shall understand specific meanings of the above terms based on specific contexts of the present disclosure.

### Embodiment

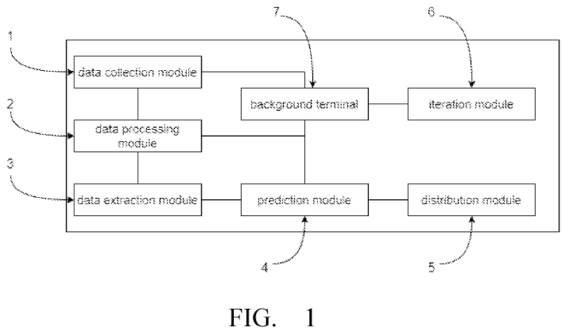

In the present embodiment, as shown in FIG. 1, an E-commerce intelligent distribution system, including a data collection module 1 wherein the data collection module is configured to collect and record data related to users, products, and transactions.

The data collection module is configured to obtains data from various data sources, including user behavior data, product information and content data; and thereafter reasonably store collected data for subsequent analysis.

In the present disclosure, in the process of collecting data, the data collection module protects user information security through data encryption and authority control. The collected data can be stored using relational databases and data warehouses.

The data processing module, which is communicated with the data collection module, is configured to preprocess the recorded data and remove invalid data and abnormal values.

The data processing module is configured to integrate and convert data from different sources and formats, process a real-time data; and thereafter store data after consolidated.

The present disclosure performs cleaning, preprocessing and statistical analysis on the collected raw data to ensure the integrity and accuracy of the data. At the same time, cluster analysis and association rule mining are performed to discover valuable information and patterns. The processed data will be stored together with the mined information, making it easier for operators to organize and utilize through the backend terminal.

The data extraction module, which is communicated with the data processing module, is configured to extract relevant features from data after preprocessed, and perform sieving to the relevant features according to an importance of the features.

Specifically, the E-commerce intelligent distribution system can visually display the extracted data in the form of charts, reports through the backend terminal; supports real-time data extraction, making it convenient for operators to observe the extracted data in real time, and provides real-time feedback on the user's interest trend in the current environment based on the extracted data.

The prediction module, which is communicated with the data extraction module, is configured to predict user's preferences level in specific content or products by analyzing user's behavioral data including browsing history, search history, and upvote records, and the prediction module simultaneously predict the user's future behavior trend based on the user's behavior data.

The prediction module analyzes the data extracted by the data extraction module, and records analysis results, and recommend and distribute arrangements in advance based on the analysis results.

The present disclosure can predict possible future behavioral trends of users via various prediction methods.

Although have some shortcomings, neural network models still widely adopted when it comes to predictions. The neural network models can consider multiple influencing factors as input and produce accurate prediction results. In this case: x is an input, y represents a output, W is a weight, and T is a threshold.

The activation function of most neural networks is a linear function, and the output of the neural network is the weighted sum of the input value and the weight;

$$y = {\sum }_{i = 1}^{n} {w}_{i} {x}_{i} - b = {x}^{T} w - b .$$

In this case: b represents the neuron threshold.

The most widely adopted function today is the S function, which is a smooth curve; as shown below:

$$f ( x ) = \frac{1}{1 + {e}^{- x}} \qquad$$

In this case: an LM optimization neural network algorithm may be adopted; first, a set of vectors is set x=(x₁, x₂, . . . , xₙ); a Newton method is employed as a training principle, and the expression is shown as follows:

$${x}^{k + 1} = {x}^{k} - {H}_{k}^{- 1} g$$

In the above expression, Hₖ⁻¹ is the inverse matrix of the Hessian matrix, and g is the point function gradient.

Assume that the weights of neurons i and j are wᵢⱼ, there are M samples (xₖ, yₖ), and the output for input and output xₖ, yₖ, i is Oᵢₖ. For neuron j in layer s, when k samples are output, the output of node j is shown as follows:

$${O}_{j k}^{s} = {\sum }_{j} {w}_{j k} {O}_{j k}^{s - 1} + {b}_{j}^{s}$$

The output of the j neuron of the k-th sample in the s-1layer is the neuron threshold bⱼ^{s}; the error function is:

$${E}_{k} = \frac{1}{2} \sum {( {y}_{i j}^{•} - {y}_{i j} )}^{2} .$$

In the above expression, yᵢⱼ is actual value, and yᵢⱼ^{⋅} is output value; the variance error is shown as follows:

$$E = \frac{1}{2 M} {\sum }_{k = 1}^{N} {E}_{k}$$

Assume that the S layer of the neural network has n nodes, and the error vector e(w) of the weight is a column vector; the error sum function E is shown as follows:

$$E ( W ) = \frac{1}{2} {\sum }_{i = 1}^{n} {e}_{i}^{2} ( w ) = \frac{1}{2} {e}^{T} ( W ) e ( W )$$

The gradient of E(W) is shown as follows:

$$∇ E ( W ) = {\sum }_{i = 1}^{n} {e}_{i} ( w ) \frac{\partial {e}_{i} ( w )}{\partial ( w )} = {J}^{T} ( W ) e ( W )$$

The LM algorithm updates the weights and thresholds as follows:

$$W ( k + 1 ) = {{[ W ( k ) - {J}^{T} ( {W}_{k} ) J ( {W}_{k} ) + μ ]}^{-}}^{1} {J}^{T} ( {W}_{k} ) e ( {w}_{k} )$$

Since the matrix is not necessarily reversible, μ is added to ensure reversibility, where μ is an n*n matrix greater than 0.1.

The prediction module of the E-commerce intelligent distribution system can recommend personalized content or product that best suits the user's interests based on the user's characteristics and behavior patterns.

The distribution module, which is communicated with the prediction module, is configured to automatically recommend pertinent products and services according to the user's requirements and the preferences level.

Specifically, the distribution module regularly provides processed data, reports and statistical results to other technical users in real time or to support decision-making and monitor user data; and automatically recommend product items that users are interested in to improve user experience and satisfaction.

The iteration module is configured to collect various real-time user data and to monitor and analyze the data collection module, mark defective data, and transmit marked data to the background terminal. The background terminal is configured to repair the data marked by the iteration module.

Specifically, the functions of the background terminal can be expanded and enhanced based on market feedback and user needs to meet changing user needs. Through user research, feedback, and data analysis, the present disclosure will improve user experience and increase satisfaction. Simultaneously, the present disclosure will conduct comprehensive testing and verification of the backend terminal 7, including functional, performance and security testing to ensure its quality and reliability and reduce the occurrence of problems.

The storage component may be a universal serial bus (USB) flash drive, but is not limited to a system of electricity, magnetism, light, electromagnetism, infrared or semiconductors, or a system or a device, or any combination of the above. More specific examples of a computer-readable storage media includes, but are not limited to: electrical connection having one or more wires, a portable computer disk, a portable computer hard disk, a random access memory (RAM), a read-only memory (ROM), an erasable programmable read-only memory, an optical fiber, a portable compact disk read only memory (CD ROM), an optical storage device, a magnetic storage device, or any suitable combination of the above. In the present embodiment, the computer-readable storage medium may be any tangible medium that contains or stores programs, and the programs can be executed by an instruction execution system, a system, a device, or a combination thereof. Program codes contained in the computer-readable storage medium can be transmitted by any suitable medium, including but not limited to wires, fiber optic cables, radio frequency (RF), and so on, or by any suitable combination thereof.

Although the embodiments of the present disclosure have been shown and described, any ordinary skilled person in the art can perform various changes, modifications, substitutions, and variations on the embodiments without departing from the principles and spirit of the present disclosure. Therefore, the above drawings and descriptions are illustrative in nature and should not be construed as limiting the scope of the claims of the present disclosure.

We claim:

1. An E-commerce intelligent distribution system, comprising:
a data collection module, wherein the data collection module is configured to obtain, collect and record data related to users, products and transactions;
a data processing module, wherein the data processing module is communicated with the data collection module, and the data processing module is configured to preprocess the recorded data and remove invalid data and abnormal values;
a data extraction module, wherein the data extraction module is communicated with the data processing module, and the data extraction module is configured to extract relevant features from data after preprocessed, and perform sieving to the relevant features according to an importance of the features;
a prediction module, wherein the prediction module is communicated with the data extraction module, the prediction module is configured to predict user's preferences level in specific content or products by analyzing user's behavioral data including browsing history, search history and upvote records, and the prediction module simultaneously predict the user's future behavior trend based on the user's behavior data;
a distribution module, wherein the distribution module is communicated with the prediction module, and the distribution module is configured to automatically recommend pertinent products and services according to the user's requirements and the preferences level; and
an iteration module, wherein the iteration module is configured to collect various real-time user data.

2. The E-commerce intelligent distribution system according to claim 1, wherein the data collection module is configured to obtain data from various data sources including user behavior data, product information and content data; and thereafter store collected data for subsequent analysis.

3. The E-commerce intelligent distribution system according to claim 1, wherein the data processing module is configured to integrate and convert data from different sources and formats, process a real-time data; and thereafter store data after consolidated.

4. The E-commerce intelligent distribution system according to claim 1, wherein the prediction module is configured to analyze the data extracted by the data extraction module, and record analysis results, and recommend and distribute arrangements in advance based on the analysis results.

5. The E-commerce intelligent distribution system according to claim 1, wherein the distribution module is configured to recommend personalized content or products to users based on preferences and behavioral characteristics thereof.

6. The E-commerce intelligent distribution system according to claim 1, further comprising a background terminal, wherein the iteration module is configured to monitor and analyze the data collection module, mark defective data, and transmit marked data to the background terminal.

7. The E-commerce intelligent distribution system according to claim 1, wherein the background terminal is configured to repair the data marked by the iteration module and to visually display the real-time data.
